(19) United States
(12) Patent Application Publication
(10) Pub. No.: US 2026/0225713 A1
(43) Pub. Date: Aug. 6, 2026

(54) AIRCRAFT WITH A MODULAR ELECTRIC FLIGHT CONTROL SYSTEM

(71) Applicant: AIRBUS HELICOPTERS, Marignane Cedex (FR)

(72) Inventors: Clément LETONNELIER, La Fare Les Oliviers (FR); Constance LAUBY, Aix-En-Provence (FR); Adrien OTT, Salon De Provence (FR); Pascal IZZO, Berre L'etang (FR)

(73) Assignee: AIRBUS HELICOPTERS, Marignane Cedex (FR)

(21) Appl. No.: 19/407,093

(22) Filed: Dec. 3, 2025

(30) Foreign Application Priority Data
Feb. 4, 2025 (FR) FR2501114

(51) Int. Cl. B64C 27/56

(52) U.S. Cl. CPC B64C 27/56

(57) ABSTRACT

A rotorcraft comprising a first connector assembly and a second connector assembly connected to a control system. The control system determines, during an initialization phase, a current configuration among the reference configurations by communicating through the first connector assembly and the second connector assembly, the plurality of reference configurations comprising: i) a two-pilot configuration wherein two identical complete human-machine interfacing sets are connected to the first connector assembly and to the second connector assembly respectively, and ii) at least one simplified configuration wherein a single complete human-machine interfacing set is connected to one of the first connector assembly and the second connector assembly.

### CROSS REFERENCE TO RELATED APPLICATION

This application claims priority to French patent application No. FR 25 01114 filed on February 4, 2025, the disclosure of which is incorporated in its entirety by reference herein.

### TECHNICAL FIELD

The present disclosure relates to an aircraft provided with a modular electric flight control system.

An aircraft conventionally comprises control members that can be operated by a pilot or a co-pilot, and that act on aerodynamic control surfaces in order to steer this aircraft.

### BACKGROUND

Thus, a rotorcraft may be provided with at least one main rotor contributing to its lift or even its propulsion. A rotorcraft may also be equipped with a device for controlling its movements along a yaw axis. The anti-torque device comprises, for example, at least one auxiliary rotor, possibly of small size and with an almost horizontal axis of rotation. Such an auxiliary rotor may, for example, comprise a standard rotor, a ducted rotor, or even a propeller. The blades of the various rotors thus represent controllable aerodynamic control surfaces for steering the rotorcraft.

A rotorcraft conventionally comprises a cockpit housing at least one human-machine interfacing set for acting on the pitch of the blades of the rotors. Such a human-machine interfacing set comprises a first control member, such as a lever usually referred to as the "collective pitch lever". In addition, the human-machine interfacing set comprises a second control member, such as a lever usually referred to as the "cyclic pitch lever". Finally, the human-machine interfacing set comprises a third control member, such as a rudder bar, for varying the pitch of the blades of the auxiliary rotor.

In the case of a rotorcraft with electric flight controls, each control member is associated with a control box. Thus, each piloting command generated by the action of a control member is transmitted in the form of an electrical signal emitted by a control box. For example, this electrical signal is a function of the amplitude and direction of a movement operated by a control member, or of the operation of a button of the control member.

The control box is connected, by a wired link for example, to a control system configured to control a position of each aerodynamic control surface. Such a control system may comprise a processing subassembly determining a positional setpoint to be achieved by one or more aerodynamic control surfaces as a function of at least one piloting command encoded by a control box and of the current situational state of the aircraft. Such a positional setpoint may be a pitch angle of a blade, a deflection angle of a flap or a speed of rotation of a rotor or a propeller, for example. Finally, the control system comprises at least one actuating subassembly controlling an actuator acting directly or indirectly on one or more aerodynamic control surfaces as a function of a positional setpoint determined by the processing subassembly.

An aircraft may comprise a single pilot human-machine interfacing set.

Another type of rotorcraft referred to as a "two-pilot aircraft" may comprise a pilot and a co-pilot sitting side-by-side in a two-pilot configuration. The aircraft then comprises a human-machine interfacing set intended for the pilot and a human-machine interfacing set intended for the co-pilot, hereinafter referred to respectively as the "pilot human-machine interfacing set" and "co-pilot human-machine interfacing set". The control members of the pilot and co-pilot human-machine interfacing sets of each type are mechanically connected to provide the pilots with an adequacy of positions of the control members. The regulatory constraints regarding the mandatory presence of the co-pilot vary according to the category of the aircraft, and in particular the maximum number of passengers. For example, two-pilot aircraft carrying between 9 and 18 passengers may be operated by a single pilot under "visual flight" conditions. Conversely, two-pilot aircraft carrying more than 18 passengers are required to be operated by two pilots. Many operators therefore choose an aircraft with a two-pilot configuration and operate the aircraft either as a single-pilot or as a two-pilot depending on the mission.

In this context, document FR3005032 describes a symmetrical pilot station of a rotorcraft, comprising seats arranged side-by-side and side access doors.

Document US 2019/0161170 A1 describes a control system comprising a central control stick with two handles and two levers arranged respectively on side brackets.

Document US 2022/0266983 A1 describes a flight control computer system configured to control an aircraft, in a primary control mode, using signals generated by a primary sensor assembly in response to pivotal movements of a primary control element. In a secondary control mode, the flight control computer system is configured to control the aircraft using signals generated by a secondary sensor assembly in response to pivoting movements of a secondary control element.

Document US 2024/0010331 A1 describes an aircraft provided with a mechanical control system provided with a pilot station for a pilot, having a first main handle and a first secondary handle sliding in a channel of an armrest for respectively cyclically and collectively controlling the pitch of blades. A second main handle and a second secondary handle can be fitted to a pilot station for a co-pilot. All the handles are in mechanical connection with a mechanical flight control chain.

Document WO2004/110860 A1 discloses a helicopter provided with a front module that can be connected to a central module that is common to all missions and contains the essential flight components. This main module comprises, in particular, the engine, the flight control elements, the rotary wing, a tail boom, a landing gear and electrical systems.

### SUMMARY

Therefore, one object of the present disclosure is to propose an innovative aircraft provided with a modular flight control system.

The disclosure relates to a rotorcraft comprising an electric flight control system, the electric flight control system comprising a control system for controlling at least one aerodynamic control surface as a function of at least one command.

The electrical flight control system comprises a first connector assembly and a second connector assembly connected to the control system by at least one wired link, optionally an electrical or optical link. At least one human-machine interfacing set is reversibly connected either to the first connector assembly or to the second connector assembly, the human-machine interfacing set comprising at least one control member provided with a control box configured to generate said command following an action on the control member. During each flight, said rotorcraft has a current configuration selected from a plurality of reference configurations; the control system determines, during an initialization phase, the current configuration from among the reference configurations by communicating through the first connector assembly and the second connector assembly, said plurality of reference configurations comprising:

a two-pilot configuration wherein two identical complete human-machine interfacing sets are connected respectively to the first connector assembly and to the second connector assembly; and

at least one simplified configuration wherein a single complete human-machine interfacing set is connected to one of the first connector assembly and second connector assembly.

The rotorcraft has two connector assemblies that can be connected to two human-machine interfacing sets, respectively. Each connector assembly comprises one or more connectors connected by one or more wired links to the control system. Such a wired link may, for example, take the form of an electrical and/or optical harness. The control box or boxes of the human-machine interfacing set to be connected are connected by at least one wired link to at least one connector either of the first connector assembly or of the second connector assembly, the function of the connector assembly concerned being to acquire said at least one command and to transmit it to the control system

Each human-machine interfacing set may comprise one or more control members. The expression "complete human-machine interfacing set" refers to a particular human-machine interfacing set comprising the maximum possible number of control members, unlike a simplified set described below that has fewer control members or even a single control member. Optionally, a control member may be connected to a plurality of connectors of the same connector assembly.

Thus, during a preparatory phase, an operator may choose, depending on the mission to be carried out, to install one or two human-machine interfacing sets, in order to place the aircraft in a single-pilot or two-pilot configuration, or even in an intermediate configuration described below. In order to switch from one configuration to another, it is sufficient to attach the control members concerned to the aircraft and to connect them, i.e., to connect them to one or more connectors, either directly via their own wiring or indirectly via at least one adaptive wired link, for example. The mechanical connections for attaching the control members may be identical and may comprise a quick assembly/disassembly system. Furthermore, the disclosure can make it possible to implement links between the connectors and the control system with a number/definition of standardized interconnection signals, and in particular identical links from one aircraft to another.

The control system is then configured to detect the current configuration, and to be parameterized according to this current configuration. The control system may apply piloting laws that vary depending on the current configuration.

This architecture represents a change of concept allowing the establishment of two completely independent pilot stations in two areas of an aircraft cockpit, that can provide a substantial advantage in terms of comfort. In a single-pilot configuration, it is in particular possible to arrange a single human-machine interfacing set in one area, that enables space to be freed up in the other area of the cockpit, for example.

The independence of the pilot stations makes it possible to propose a cockpit solution for rotorcraft with versatile electrical flight controls allowing, in a few minutes, the change of configuration from one pre-established configuration to another. Switching between these pilot station configurations offers the appreciable advantage of being carried out directly at the rotorcraft operator's premises, and therefore without having to use a maintenance center. An operator can then adapt the configuration of the aircraft according to the mission to be carried out, with minimum immobilization.

Due to the versatility introduced, this architecture can enable two control members to be switched at one pilot station, independently of the other pilot station. For example, one pilot station may comprise two subassemblies of connectors laterally on either side of a seat, the same control member being able to be arranged to the right or to the left of the seat depending on the preference of the pilot or co-pilot.

The rotorcraft may also comprise one or more of the following features.

According to one possibility, the one or more complete human-machine interfacing sets may each comprise a first control member for controlling a pitch of blades of a main rotor, as well as a second control member for controlling said pitch of blades of the main rotor differently than the first control member, and a third control member for controlling a pitch of blades of an auxiliary rotor.

According to a conventional alternative, the first control member may be in the form of a stick controlling the pitch of the blades of the main rotor in order to incline the lift vector, and the second control member may be in the form of a lever controlling the pitch of the blades of the main rotor to control the norm of the lift vector.

According to an alternative piloting by objective, the first control member and the second control member can establish setpoints, for example a speed setpoint and a heading or attitude setpoint, the control system controlling the pitch of the blades of the main rotor and of the auxiliary rotor in order to achieve this objective.

According to one possibility compatible with the preceding possibilities, at least one simplified configuration may comprise a strictly single-pilot configuration comprising only one complete human-machine interfacing set connected to the first connector assembly or to the second connector assembly.

In the strictly single-pilot configuration, the co-pilot station is removed. This configuration makes it possible to obtain a weight saving compared to the two-pilot configuration or, above all, a possible reorganization of the relevant area of the cockpit.

According to one possibility compatible with the preceding possibilities, said at least one simplified configuration may comprise an intermediate configuration having a complete human-machine interfacing set connected to one of the first connector assembly and the second connector assembly, and a simplified human-machine interfacing set connected to the first connector assembly or the second connector assembly that is not connected to the complete human-machine interfacing set.

The simplified human-machine interfacing set comprises fewer control members than a complete human-machine interfacing set.

For example, the simplified human-machine interfacing set comprises only one control member.

In this case, this control member may be configured to control a roll angle, a pitch angle, a yaw angle and a speed of the aircraft.

In the simplified configuration, one pilot station is a conventional pilot station, and the other station is an additional station. The additional station is drastically simplified and consists, for example, of a single four-axis handle, incorporating its control box in order to acquire the commands. With such an interface, piloting the aircraft is facilitated and allows, in the event of unavailability of the pilot station (breakdown, problem with the pilot, etc.), piloting by a co-pilot or operator with a lower level of qualification.

The four-axis stick can be located on an outer side of the aircraft to facilitate incorporation of other equipment at a center console.

According to one possibility compatible with the preceding possibilities, the control system may comprise a processing subassembly determining at least one positional setpoint to be reached by at least one aerodynamic control surface as a function of at least one command, the control system comprising at least one actuation subassembly configured to generate, as a function of said positional setpoint, at least one actuation setpoint that is transmitted to at least one actuator in order to control an aerodynamic control surface, the processing subassembly being connected to the first connector assembly and to the second connector assembly and being configured to determine the current configuration as a function of information received by each connector of the first connector assembly and the second connector assembly.

The processing subassembly can determine, in a conventional manner, which control member is connected to which connector by means of a conventional addressing method.

The processing subassembly may be configured to select a control law to be applied as a function of the current configuration, or even the human-machine interfacing set transmitting a command. For example, in the intermediate configuration, the processing subassembly may apply a first set of stored laws when a control member of the complete human-machine interfacing set issues a command, and a second set of laws when the single control member of the simplified human-machine interfacing set issues a command.

According to one possibility compatible with the preceding possibilities, said rotorcraft may comprise a display, the control system being configured to transmit at least one carrier signal of the current configuration directly or indirectly to the display, said display displaying at least one carrier symbol of the current configuration.

This enables a crew to visually check the configuration of the aircraft.

According to one possibility compatible with the preceding possibilities, in the two-pilot configuration, each complete human-machine interfacing set may comprise a switch, said switch inhibiting the complete human-machine interfacing set in the event of activation of this switch.

It is thus possible to passivate a complete human-machine interfacing set, without having to change the configuration.

According to one possibility compatible with the preceding possibilities, in the two-pilot configuration, two control members performing the same function respectively of the two complete human-machine interfacing sets may be passive members with return to a predetermined position in the absence of force, the control system being configured to inhibit one of the two control members if the two control members are operated at the same time.

When a control member is not operated, this control member returns to a reference position. In order to facilitate the change between configurations, this feature makes it possible to avoid the arrangement of a mechanical device between the control members of two human-machine interfacing sets.

Alternatively, in the two-pilot configuration, two control members performing the same function respectively of the two complete human-machine interfacing sets may be active members, and when one of the two control members is moved then the control system can be configured to transmit a signal to the other control member to control an identical movement.

The use of two active complete human-machine interfacing sets can facilitate the change between configurations, this feature makes it possible to avoid the arrangement of a mechanical device between the control members of two human-machine interfacing sets.

According to one possibility compatible with the preceding possibilities, the first connector assembly and the second connector assembly are located laterally on either side of a vertical plane extending from a nose to a tail of the rotorcraft.

In a conventional rotorcraft, the first connector assembly and the second connector assembly are located, for example, to the left and right of the cockpit depending on the direction of travel of the aircraft.

The disclosure further relates to the method implemented by such a rotorcraft.

Thus, the disclosure relates to a control method for a rotorcraft comprising an electric flight control system, the electric flight control system comprising a control system for controlling at least one aerodynamic control surface as a function of at least one command.

The electric flight control system comprising a first connector assembly and a second connector assembly connected to the control system by at least one wired link, the method comprises:

- connecting a single human-machine interfacing set to the first connector assembly or to the second connector assembly, or connecting two human-machine interfacing sets to the first connector assembly and to the second connector assembly respectively; and

identifying with the control system, during an initialization phase, a current configuration among a plurality of reference configurations by communicating with the first connector assembly and the second connector assembly, said plurality of reference configurations comprising:

a two-pilot configuration wherein two identical complete human-machine interfacing sets are connected respectively to the first connector assembly and to the second connector assembly; and

at least one simplified configuration wherein a single complete human-machine interfacing set is connected to one of the first connector assembly and second connector assembly.

Said at least one simplified configuration may comprise a strictly single-pilot configuration comprising only one complete human-machine interfacing set connected either to the first connector assembly or to the second connector assembly.

Said at least one simplified configuration may comprise an intermediate configuration having a complete human-machine interfacing set connected to one of the first connector assembly and the second connector assembly, and a simplified human-machine interfacing set connected to the first connector assembly or the second connector assembly that is not connected to the complete human-machine interfacing set.

### BRIEF DESCRIPTION OF THE DRAWINGS

The disclosure and its advantages appear in greater detail from the following description of examples given by way of illustration with reference to the accompanying figures, wherein:

FIG. 1 is a diagram illustrating a rotorcraft according to the disclosure;

FIG. 2 is a diagram illustrating a flight control system according to the disclosure in the two-pilot configuration;

FIG. 3 is a diagram illustrating a flight control system according to the disclosure in an intermediate configuration;

FIG. 4 is a diagram illustrating a flight control system according to the disclosure in the strictly single-pilot configuration; and

FIG. 5 is a diagram illustrating the method of the disclosure.

### DETAILED DESCRIPTION

Elements present in more than one of the figures are given the same references in each of them.

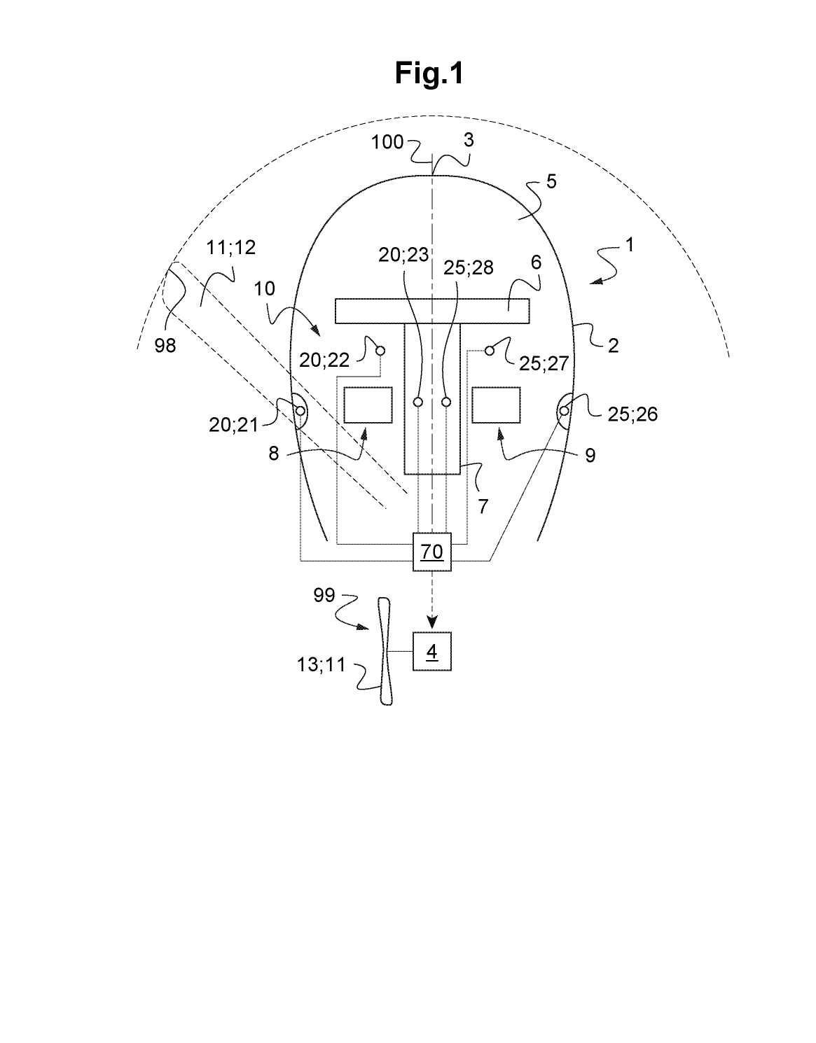

FIG. 1 shows a plan view of a rotorcraft 1 according to the disclosure.

The rotorcraft 1 has an airframe 2 that extends from front to rear and along a vertical plane 100, from a nose 3 to a tail 4. The rotorcraft 1 further comprises a cockpit 5 in the airframe 2. For example, the cockpit 5 houses at least one dashboard 6 and/or a central console 7.

In particular, the cockpit 5 may comprise two stations 8, 9, each of which may form a pilot station. According to the illustrated example, the two stations 8 and 9 are situated on either side of the vertical plane 100 and on either side of the central console 7.

Furthermore, the rotorcraft 1 comprises at least one movable aerodynamic control surface 11 for controlling the movements of the rotorcraft 1. Such an aerodynamic control surface 11 may take the form of a blade, a flap, etc.

For example, the rotorcraft 1 comprises a main rotor 98, this main rotor 98 being able to contribute to at least the lift of the rotorcraft 1. The main rotor 98 comprises at least one blade 12 forming an aerodynamic control surface 11 and is illustrated by dashed lines.

In addition, the rotorcraft 1 may comprise an auxiliary rotor 99, this auxiliary rotor 99 being able to contribute at least to controlling the yaw movement of the rotorcraft 1. The auxiliary rotor 99 then comprises at least one blade 13 forming an aerodynamic control surface 11. According to the illustrated example, the auxiliary rotor 99 may be a tail rotor located at the tail 4 of the rotorcraft 1. According to another example, an auxiliary rotor 99 may be in the form of a propeller.

Independently of these aspects, the rotorcraft 1 comprises an electric flight control system 10. This electric flight control system 10 comprises a control system 70 for controlling at least one aerodynamic control surface 11 as a function of at least one piloting command, referred to more simply as a "command".

The electrical flight control system 10 then comprises a first connector assembly 20 and a second connector assembly 25 connected to the control system 70, for example via one or more electrical and/or optical wired links. The first connector assembly 20 and the second connector assembly 25 are optionally located laterally on either side of the vertical plane 100, or are even symmetrical with respect to each other.

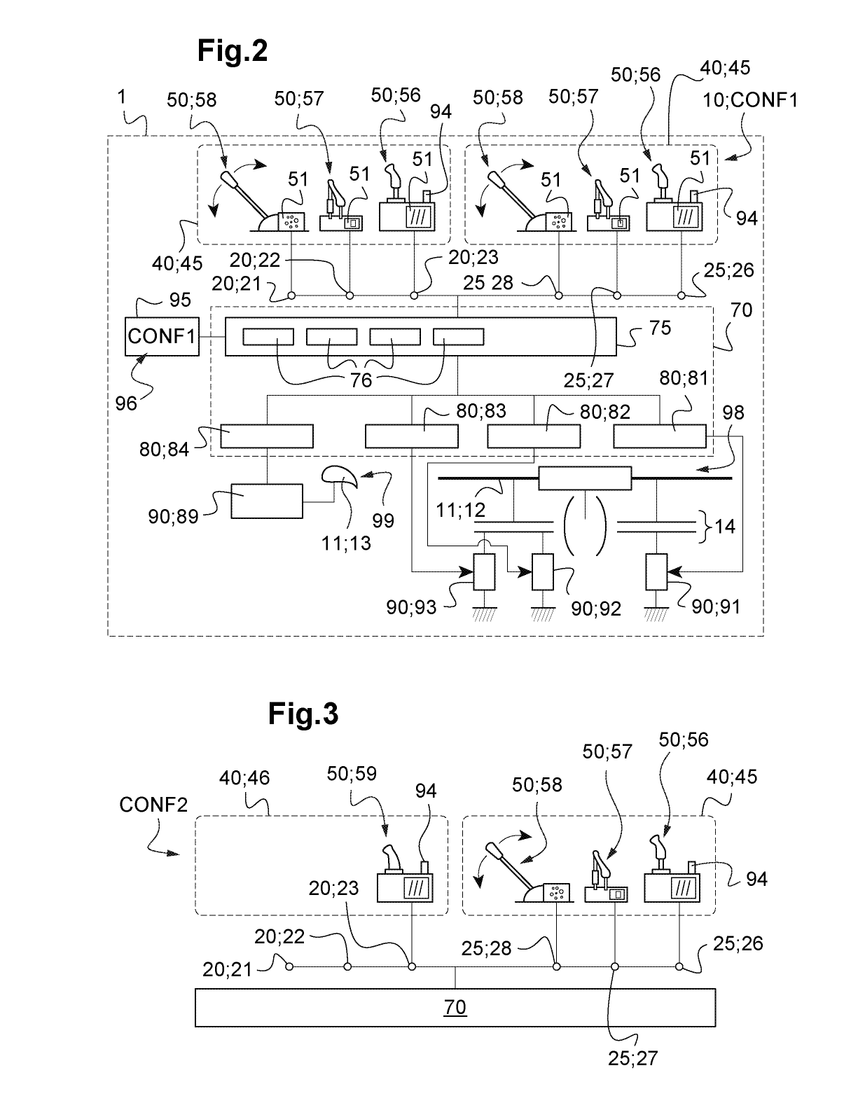

According to the example in FIG. 2, each connector assembly 20, 25 may comprise three subassemblies intended respectively for three control members, each subassembly being able to comprise one or more connectors. For simplicity and in order not to burden the figure, the first connector assembly 20 may comprise three subassemblies each having at least one connector 21, 22, 23, and the second connector assembly 25 may comprise three subassemblies each having at least one connector 26, 27, 28. For example, connectors 21, 22, 23, 26, 27, 28 are identical.

Each connector assembly 20, 25 has the function of acquiring at least one command, for example in the form of an electrical or optical command signal, and of transmitting it to the control system 70. This control system 70 is configured to control one or more aerodynamic control surfaces 11 as a function of the one or more commands.

By way of illustration, the control system 70 comprises a processing subassembly 75 determining at least one positional setpoint to be reached by at least one aerodynamic control surface 11 as a function of at least one command. Conventionally, the processing subassembly 75 may comprise one or more computers 76.

The term "computer" means a processing unit that can perform digital processing with a processor or other forms of integrated circuit comprising logic circuits. The processing unit may perform analog processing with analog components integrated or not into integrated circuits, such as operational amplifiers, for example. The term "processor" may refer equally to a central processing unit or CPU, a graphics processing unit or GPU, a digital signal processor or DSP, a microcontroller, etc.

In addition, the control system 70 may comprise at least one actuation subassembly 80, configured to generate, as a function of said positional setpoint, at least one actuating setpoint that is transmitted to at least one actuator 90 for directly or indirectly controlling an aerodynamic control surface 11 via a mechanical drive chain.

Therefore, the processing subassembly 75 is connected, by one or more wired links illustrated by continuous lines, to each connector 21-23, 24-26 of the first connector assembly 20 and the second connector assembly 25. As a function of the commands received, via the wired link, the processing subassembly 75 transmits a positional setpoint to at least one actuation subassembly 80, as a function of at least one stored law, this actuation subassembly 80 controlling at least one actuator 90.

According to the illustrated example, the pitch of the blades 12 of the main rotor 98 may be modified by at least three servo-controls 91, 92, 93 articulated to a swashplate system 14 connected to each blade 12 by at least one pitch change rod. According to this same example, the pitch of the blades 13 of the auxiliary rotor 99 can be modified by at least one actuator 89.

In order to generate a command, on each flight, the rotorcraft 1 comprises at least one human-machine interfacing set 40 reversibly connected to the first connector assembly 20 or to the second connector assembly 25.

Each human-machine interfacing set 40 comprises at least one control member 50 provided with a control box 51. Reference 50 designates any control member and reference 51 designates any control box.

The control box 51 of a control member 50 is then connected by at least one wired link to at least one connector 21-23, 24-26 of a connector subassembly. The control box 51 of a control member 50 is configured to generate said command as a result of an action on the control member 50, namely as a result of a movement of the control member or the operation of a button of the control member.

In particular, the rotorcraft 1 is, during each flight, in a current configuration selected from a plurality of reference configurations CONF1, CONF2, CONF3. The reference configurations comprise a two-pilot configuration CONF1, and at least one simplified configuration that is either strictly single-pilot or intermediate.

The control system 70, and according to the illustrated example the processing subassembly 75, are then configured to determine the current configuration as a function of information received from the control member or members connected through each connector of the first connector assembly 20 and second connector assembly 25. In addition, the control system 70, and according to the illustrated example the processing subassembly 75, are then configured to control the one or more actuators 90 accordingly.

Optionally, the rotorcraft 1 may comprise a display 95 controlled directly or indirectly by the control system 70. The control system 70, and according to the illustrated example the processing subassembly 75, are then configured to transmit at least one carrier signal of the current configuration directly or indirectly via an avionics system of the rotorcraft 1 to the display 95. The display 95 then displays at least one symbol 96 carrying the current configuration. According to the illustrated example, the symbol 96 may take the form of a sequence of characters designating the current configuration.

FIG. 2 illustrates a two-pilot configuration CONF1 wherein two identical human-machine interfacing sets called complete human-machine interfacing sets 45 are connected, directly or indirectly via at least one adapter link, respectively to the first connector assembly 20 and to the second connector assembly 25. FIG. 1 illustrates connector subassemblies each having a single connector and therefore control members connected to a single connector. According to another possibility, each connector assembly 20 may comprise at least one connector subassembly having at least two connectors, and a control member may be connected to a plurality of connectors of the same connector subassembly 80, as a function of at least one stored law, this actuation subassembly 80 controlling at least one actuator 90.

The expression "complete human-machine interfacing set 45" means an interfacing set that comprises, for example:

a first control member 56 for controlling a pitch of blades 12 of a main rotor 98, such as a conventional cyclic stick;

a second control member 58 for controlling said pitch of the blades 12 of the main rotor 98 differently than the first control member 56, such as a conventional collective pitch lever; and

a third control member 57, for example a rudder bar, for controlling a pitch of blades 13 of an auxiliary rotor 99.

FIG. 1 illustrates control members connected to a single connector, but one or more interfaces may be connected to a plurality of connectors of the same subassembly of connectors. For example, the second connector assembly 25 may comprise a subassembly having a plurality of connectors 26, and the first connector assembly 20 may comprise a subassembly having a plurality of connectors 23 instead of the single connector 23 and the single connector 26 shown in the example of FIG. 2, wherein the first control member 56 of one complete human-machine interfacing set may be connected to a plurality of connectors 26, and the first control member 56 of the other complete human-machine interfacing set may be connected to a plurality of connectors 23.

In the two-pilot configuration CONF1, each complete human-machine interfacing set 45 may be provided with a switch 94 inhibiting the corresponding complete human-machine interfacing set 45 in the event of activation of the switch 94.

For example, the switch 94 is carried by a control member 50 and connected to the control box 51 of this control member 50. When the switch 94 is activated, the associated control box 51 transmits a signal to the control system 70 indicating that the entire human-machine interfacing set 45 should be ignored.

In the two-pilot configuration CONF1, at least two control members 56; 57; 58 effectively performing the same function equip the two complete human-machine interfacing sets 45, respectively. Thus, the two complete human-machine interfacing sets 45 of FIG. 2 have two identical first control members 56, two identical second control members 58, and two identical third control members 57.

Optionally, two identical control members 50 of the two complete human-machine interfacing sets 45 are passive members with return to a predetermined position in the absence of force. Moreover, the control system 70 is configured to inhibit one of the two control members 56; 57; 58, namely to disregard it, if the two control members 56; 57; 58 are operated at the same time.

Optionally, two identical control members 50 of the two complete human-machine interfacing sets 45 are active members, namely each provided with at least one active device such as a cylinder or a motor capable of exerting a force on the control member 50. Therefore, when one of the two control members 56; 57; 58 is moved, the control system 70, and, for example, the processing subassembly 75, is configured to transmit a signal to the other control member 56; 57; 58 to command an identical movement.

Furthermore, in a simplified configuration CONF2, CONF3, a single complete human-machine interfacing set 45 is connected either to the first connector assembly 20 or to the second connector assembly 25.

FIG. 3 illustrates a simplified configuration in the form of an intermediate configuration CONF2. In this intermediate configuration CONF2, the rotorcraft 1 comprises a complete human-machine interfacing set 45 connected to one of the first connector assembly 20 and second connector assembly 25, and a simplified human-machine interfacing set 46 connected to the other connector assembly 20, 25. The simplified human-machine interfacing set 46 comprises only one control member 59, for example capable of controlling the rotorcraft 1 along four axes.

Thus, the control system 70, and in particular the processing subassembly 75, applies at least one first law to generate a setpoint when one of the control members 50 of the complete human-machine interfacing set 45 is operated, and at least one second law when the single control member 59 of the simplified human-machine interfacing set 46 is operated.

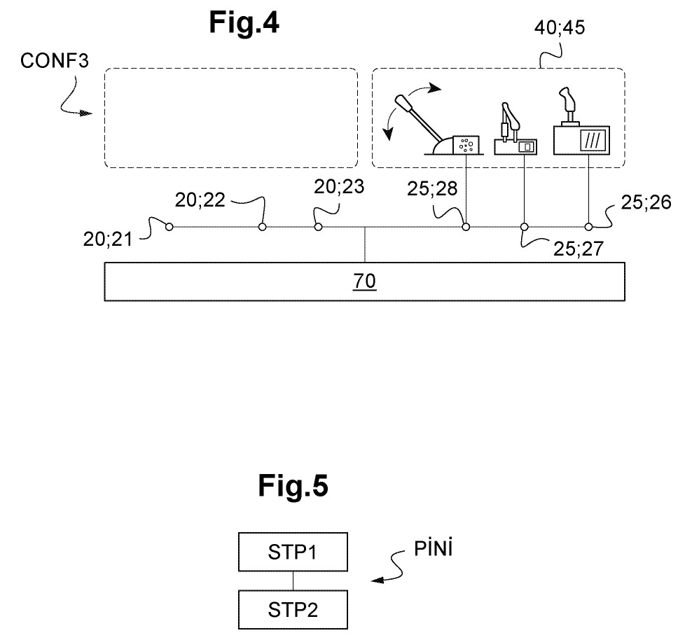

FIG. 4 illustrates a simplified configuration in the form of a strictly single-pilot configuration CONF3.

In this strictly single-pilot configuration CONF3, the rotorcraft 1 comprises only one complete human-machine interfacing set 45 connected, directly or indirectly via at least one adapter link, to the first connector assembly 20 or to the second connector assembly 25.

Under these conditions, FIG. 5 illustrates a control method of such a rotorcraft 1.

The method comprises connecting, during a step STP1, at least one human-machine interfacing set to one of the first connector assembly 20 and the second connector assembly 25. An operator connects at least one human-machine interfacing set 45 to place the rotorcraft in one of the aforementioned reference configurations.

Then, the method comprises identifying, during a step STP2 and with the control system 70, during an initialization phase PINI, the current configuration, for example using a conventional addressing method.

The method then comprises controlling the rotorcraft 1, by controlling the movement of at least one aerodynamic control surface 11 with the control system 70 as a function of the action of a control member 50.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A rotorcraft comprising an electric flight control system, the electric flight control system comprising a control system for controlling at least one aerodynamic control surface as a function of at least one command,
wherein the electric flight control system comprises a first connector assembly and a second connector assembly connected to the control system by at least one wired link, at least one human-machine interfacing set being reversibly connected either to the first connector assembly or to the second connector assembly, the human-machine interfacing set comprising at least one control member provided with a control box configured to generate the command following an action of the control member; the rotorcraft having, during each flight, a current configuration chosen from a plurality of reference configurations; the control system determining, during an initialization phase, the current configuration from among the reference configurations by communicating through the first connector assembly and the second connector assembly, the plurality of reference configurations comprising:
a two-pilot configuration wherein two identical complete human-machine interfacing sets are connected to the first connector assembly and the second connector assembly respectively; and
at least one simplified configuration wherein a single complete human-machine interfacing set is connected to one of the first connector assembly and second connector assembly.

2. The rotorcraft according to claim 1,
wherein the one or more complete human-machine interfacing sets each comprise a first control member for controlling a pitch of blades of a main rotor, as well as a second control member for controlling the pitch of blades of the main rotor differently than the first control member, and a third control member for controlling a pitch of blades of an auxiliary rotor.

3. The rotorcraft according to claim 1,
wherein the simplified configuration(s) comprise(s) a strictly single-pilot configuration comprising only one complete human-machine interfacing set connected to the first connector assembly or to the second connector assembly.

4. The rotorcraft according to claim 1,
wherein the simplified configuration(s) comprise(s) an intermediate configuration having a complete human-machine interfacing set connected to one of the first connector assembly and the second connector assembly, and a simplified human-machine interfacing set connected to the first connector assembly or to the second connector assembly that is not connected to the complete human-machine interfacing set.

5. The rotorcraft according to claim 4,
wherein the simplified human-machine interfacing set comprises only one control member.

6. The rotorcraft according to claim 1,
wherein the control system comprises a processing subassembly determining at least one positional setpoint to be reached by at least one aerodynamic control surface as a function of at least one command, the control system comprising at least one actuation subassembly configured to generate, as a function of the positional setpoint, at least one actuation setpoint that is transmitted to at least one actuator in order to control an aerodynamic control surface, the processing subassembly being connected to the first connector assembly and to the second connector assembly and being configured to determine the current configuration as a function of information received by each connector of the first connector assembly and the second connector assembly.

7. The rotorcraft according to claim 1,
wherein the rotorcraft comprises a display, the control system being configured to transmit at least one carrier signal of the current configuration directly or indirectly to the display, the display displaying at least one carrier symbol of the current configuration.

8. The rotorcraft according to claim 1,
wherein, in the two-pilot configuration, each complete human-machine interfacing set comprises a switch, the switch inhibiting the complete human-machine interfacing set in the event of activation of this switch.

9. The rotorcraft according to claim 1,
wherein, in the two-pilot configuration, two control members performing the same function respectively of the two complete human-machine interfacing sets are passive members with return to a predetermined position in the absence of force, the control system being configured to inhibit one of the two control members if the two control members are operated at the same time.

10. The rotorcraft according to claim 1,
wherein, in the two-pilot configuration, two control members performing the same function respectively of the two complete human-machine interfacing sets are active members; and wherein when one of the two control members is moved then the control system is configured to transmit a signal to the other control member to control an identical movement.

11. The rotorcraft according to claim 1,
wherein the first connector assembly and the second connector assembly are located laterally on either side of a vertical plane extending from a nose to a tail of the rotorcraft.

12. The rotorcraft according to claim 1,
wherein the control box is connected by at least one wired link to at least one connector either of the first connector assembly or of the second connector assembly, that has the function of acquiring the command(s) and transmitting it/them to the control system.

13. A method of controlling the rotorcraft comprising an electric flight control system, the electric flight control system comprising a control system for controlling at least one aerodynamic control surface as a function of at least one command,
wherein, the electric flight control system comprises a first connector assembly and a second connector assembly connected to the control system by at least one wired link, the method comprises:
connecting a single human-machine interfacing set to the first connector assembly or to the second connector assembly, or connecting two human-machine interfacing sets to the first connector assembly and to the second connector assembly respectively; and
identifying with the control system, during an initialization phase, a current configuration among a plurality of reference configurations, by communicating with the first connector assembly and the second connector assembly, the plurality of reference configurations comprising:
a two-pilot configuration wherein two identical complete human-machine interfacing sets are connected to the first connector assembly and to the second connector assembly respectively; and
at least one simplified configuration wherein a single complete human-machine interfacing set is connected to one of the first connector assembly and second connector assembly.

14. The method according to claim 13,
wherein the simplified configuration(s) comprise(s) a strictly single-pilot configuration comprising only one complete human-machine interfacing set connected either to the first connector assembly or to the second connector assembly.

15. The method according to claim 13,
wherein the simplified configuration(s) comprise(s) an intermediate configuration having a complete human-machine interfacing set connected to one of the first connector assembly and the second connector assembly, and a simplified human-machine interfacing set connected to the first connector assembly or the second connector assembly that is not connected to the complete human-machine interfacing set.
